(19) United States
(12) Patent Application Publication
(10) Pub. No.: US 2019/0135007 A1
(43) Pub. Date: May 9, 2019

(54) PRINTING SYSTEMS

(71) Applicant: Hewlett-Packard Development Company, L.P., Fort Collins, CO (US)

(72) Inventors: James P. SHIELDS, Corvallis, OR (US); Mehrgan KHAVARI, Corvallis, OR (US)

(73) Assignee: Hewlett-Packard Development Company, L.P., Fort Collins, CO (US)

(21) Appl. No.: 16/092,987

(22) PCT Filed: Jul. 19, 2016
(86) PCT No.: PCT/US2016/042950

§ 371 Date: Oct. 11, 2018

(51) Int. Cl. B41M 5/00; B41J 11/00

(52) U.S. Cl. CPC B41M 5/0011; B41M 5/0064; B41J 11/0015

(57) ABSTRACT

The present disclosure is drawn to printing systems. In one example, a printing system can include a pretreatment head and an inkjet print head. The pretreatment head can include a plasma generator to apply a plasma treatment to a polyolefin media substrate. The inkjet print head can be positioned with respect to the pretreatment head to form a printed image on the polyolefin media substrate after the plasma treatment.

### BACKGROUND

There are several reasons that inkjet printing has become a popular way of recording images on various media surfaces, particularly paper. Some of these reasons include low printer noise, variable content recording, capability of high speed recording, and multi-color recording. Additionally, these advantages can be obtained at a relatively low price to consumers. Additionally, inkjet printing is becoming more prevalent in high speed commercial printing markets, competing with more laborious offset and gravure printing technologies. However, inkjet printing tends to produce the best results when used with media specifically designed for inkjet printing. For example, paper designed for use with inkjet printing often includes fixers to immobilize colorants in the ink, absorbent layers to absorb solvents in the ink, among other ingredients selected to improve the quality of images printed on the paper. Many types of media are more difficult to use with inkjet printing. Thus, development continues in the area of inkjet printing on a variety of types of media.

### BRIEF DESCRIPTION OF THE DRAWINGS

FIG. 1A is a schematic cross-sectional top view of an example surface barrier discharge plasma generator in accordance with examples of the present disclosure.

FIG. 1B is a schematic cross-sectional end view of an example surface barrier discharge plasma generator in accordance with examples of the present disclosure.

FIG. 2A is a schematic side view of an example printing system in accordance with examples of the present disclosure.

FIG. 2B is a schematic top view of an example printing system in accordance with examples of the present disclosure.

FIG. 3 is a schematic side view of an example printing system in accordance with examples of the present disclosure.

FIG. 4 is a schematic top view of an example printing system in accordance with examples of the present disclosure.

FIG. 5 is a schematic side view of an example printing system in accordance with examples of the present disclosure.

FIG. 6 is a flowchart illustrating an example method of forming a printed image on a polyolefin media substrate in accordance with examples of the present disclosure.

FIG. 7 is a schematic cross-sectional side view of an example printed article in accordance with examples of the present disclosure.

### DETAILED DESCRIPTION

The present disclosure is drawn to printing systems employing plasma treatment of polyolefin media substrates before printing. The present disclosure also includes methods of forming printed images incorporating plasma treatment of the polyolefin media substrate and printed articles made using such methods.

A printing system according to an example of the present disclosure can include a polyolefin media substrate and a pretreatment head with a plasma generator to apply a plasma treatment to the media substrate before printing on the media substrate. This plasma pretreatment can modify the surface of the media substrate so that the surface interacts with inkjet ink printed on the surface to improve print quality.

Printing inkjet inks on polyolefin media such as polyolefin films tends to produce poor results because of a high degree of coalescence of the ink printed onto the media. Polyolefin media tends to have a non-wetting surface so that liquid ink printed on the surface beads up. This can result in an image that appears very light and faded, with small droplets of very dark color where the ink coalesced. Previous attempts at solving this problem have included treating polyolefin media with a corona treatment. This has often been performed by the manufacturer or supplier of polyolefin film. For example, polypropylene film can be treated with a corona treatment by the manufacturer. The polypropylene film can then be sold to a user for printed packaging materials or other printed material using the polypropylene film. However, this method includes several drawbacks. First, the corona treatment of the film by the manufacturer can increase the cost of the film. Additionally, the corona treatment can wear off after a period of time. Thus, the treated polypropylene film may have a limited useful life, after which the printing quality of images printed on the film would be reduced. Further, if a printer has a stock of rolls of treated polypropylene films having different ages, then inconsistent print quality may be encountered from roll to roll.

By using a plasma treatment as a part of the printing system, as described herein, a user can be assured that the treatment is fresh when the image is printed onto the media. Additionally, users can maintain a single stock of untreated polyolefin media without worrying that the media will have reduced print quality over time. This can also allow users that formerly maintained a stock of untreated polyolefin media for other purposes as well as a stock of corona treated polyolefin media to have a single stock of untreated media and plasma treat only the stock needed for printing.

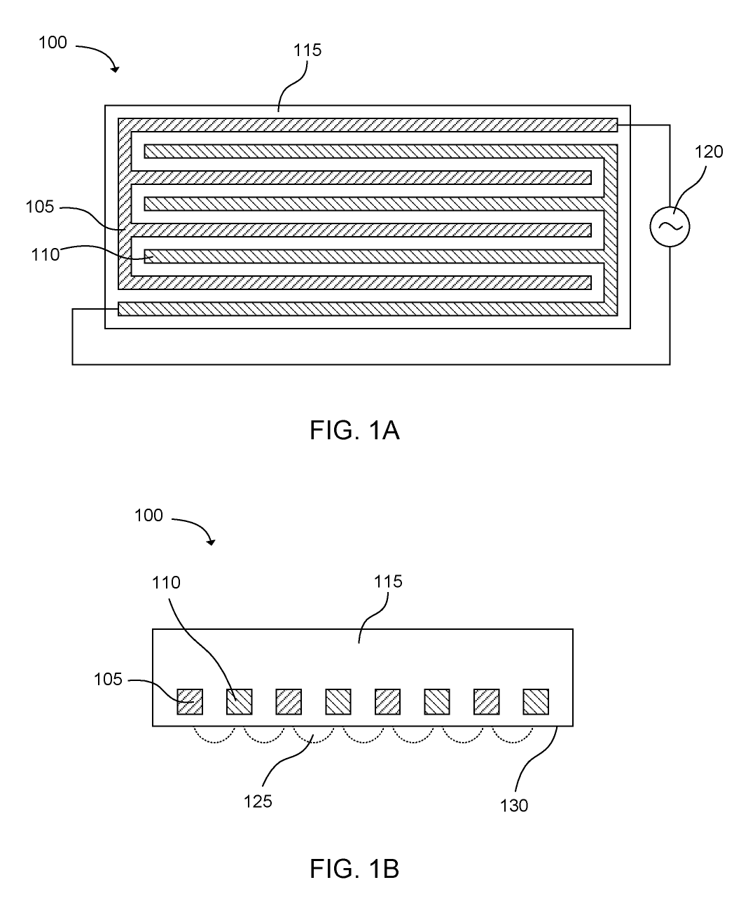

In some examples of the present technology, the plasma generator used to plasma treat the polyolefin media substrate can be a surface barrier discharge plasma generator. This particular type of plasma generator is a type of dielectric barrier discharge plasma generator, and includes electrodes located beneath a surface of a dielectric material. The electrodes can be separated from each other and from the media substrate by the dielectric material. A high voltage alternating current can be applied across the electrodes to form diffuse plasma arcs on the surface of the dielectric material. FIGS. 1A-1B show an example of a surface barrier discharge plasma generator 100 having a first electrode 105 and a second electrode 110 embedded in a dielectric plate 115. FIG. 1A shows a top cross-sectional view. A power supply 120 applies a potential difference across the first electrode and second electrode. FIG. 1B shows an end cross-sectional view. Plasma arcs 125 can form along the surface 130 of the dielectric plate.

In certain examples, the surface barrier discharge plasma generator can be a coplanar surface barrier discharge plasma generator. For example, the electrodes can be oriented in a common plane beneath the surface of the dielectric material. The surface of the dielectric material can be a flat planar surface. In other examples, the dielectric material can have a curved or other shape, and the electrodes can be oriented beneath the surface to conform to the shape of the surface. For example, the electrodes can be located at an approximately uniform distance beneath the surface.

In some examples, the power supply can provide a high voltage alternating current. In certain examples, the surface barrier discharge plasma generator can be operated at a voltage from 1 kV to 30 kV. In further examples, the high voltage alternating current can have a frequency from 1 kHz to 500 kHz. In one example, the surface barrier discharge plasma generator can be a plasma generator available from ROPLASS S.R.O., such as the RPS40, RPS400, or RPS25x plasma systems.

As shown in FIG. 1B, the first electrode 105 and second electrode 110 may be oriented in a common plane embedded within the dielectric plate 115. The plasma arcs 125 may be confined to a volume close to the surface 130 of the dielectric plate. For this reason, the plasma arcs in this example can be referred to as a “surface dielectric barrier discharge” which can be generated from a “surface barrier discharge plasma generator” described herein. This is different from a plasma generator that generates a volumetric dielectric barrier discharge. Volumetric dielectric barrier discharge occurs in a volumetric space between two electrodes, rather than from a common surface. In volumetric dielectric barrier discharge plasma systems, electrodes may be oriented in parallel planes, such as two parallel plate electrodes with a dielectric barrier between the electrodes in the space between the electrodes from two different surfaces. Thus, plasma arcs form in the volume between the electrodes. That being described, either type of plasma treatment can be used.

However, in the surface barrier discharge plasma generator 100 shown in FIG. 1B, the plasma arcs occur along a surface that is common to both electrodes of the dielectric plate. This plasma tends to be more homogenous and has a higher energy density than volumetric dielectric barrier discharge plasma.

In some examples, the plasma generated by the coplanar dielectric barrier discharge plasma generator can have a depth from 0.1 mm to 5 mm. In other words, the plasma can extend to a distance of 0.1 mm to 5 mm from the surface of the dielectric plate. In further examples, the plasma can have a depth from 0.2 mm to 2 mm or from 0.5 mm to 1 mm. The plasma can have a high energy density, for example from 50 W/cm³ to 250 W/cm³. In further examples, the plasma can have an energy density from 75 W/cm³ to 200 W/cm³ or from 80 W/cm³ to 150 W/cm³. In terms of surface area of the media substrate being treated, the energy density of the plasma can be from 0.5 W/cm² to 250 W/cm², from 1 W/cm² to 50 W/cm², or from 2 W/cm² to 10 W/cm², in some examples.

The plasma generated by the surface barrier discharge plasma generator can be “cold” plasma. For example, the plasma can have a temperature of less than 50° C. Thus, the plasma can safely be used to treat polyolefin media substrates without melting or damaging the substrates due to high temperatures.

In further examples, the surface barrier discharge plasma generator can operate at atmospheric pressure in an atmosphere of normal air. Unlike some other types of plasma generators, surface barrier discharge plasma generators in some cases do not require reduced pressure or any special gas flow to operate. For example, some other types of plasma generators employ high gas flows to blow a plasma arc out of a nozzle. The gas required for these systems in some cases includes noble gases such as Argon or Helium. In contrast, the surface barrier discharge plasma generators described herein can be used at normal atmospheric conditions.

In some examples, the surface barrier discharge plasma generator can modify the surface of the polyolefin media substrate so that the surface has improved interactions with inkjet ink. Without being bound to a particular mechanism, the plasma treatment can produce highly oxidizing species such as atomic oxygen and OH radicals. These species can react with components in the media substrate to form oxygen-containing groups such as —OH groups and carbonyl groups. In certain examples, the plasma treatment can modify the surface of the media substrate without significantly changing the pH of the surface. In other words, the plasma treatment can modify the surface by forming certain oxygen-containing groups, but without forming a substantial quantity of acid groups on the surface.

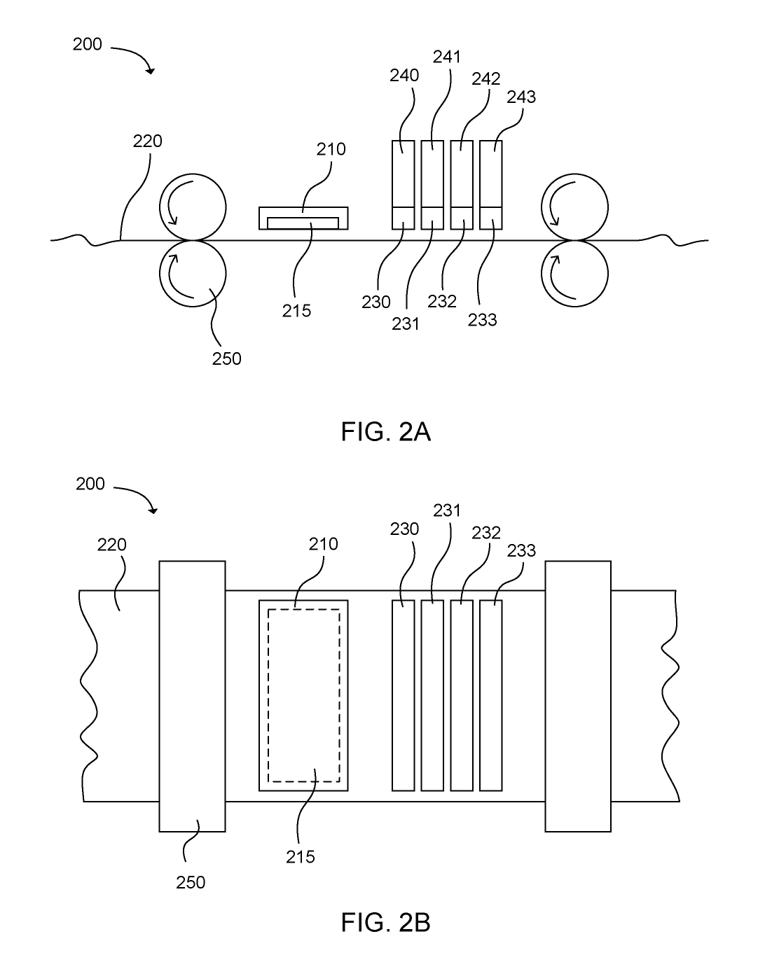

With this description in mind, FIG. 2A shows a schematic side view of a printing system 200 in accordance with examples of the present disclosure. The printing system includes a pretreatment head 210 that includes a surface barrier discharge plasma generator 215. In some examples, the plasma generator can be a component of the pretreatment head and the pretreatment head can include other components in addition to the plasma generator. In further examples, the entire pretreatment head can be the plasma generator. The pretreatment head is positioned to apply a plasma treatment to a polyolefin media substrate 220. The printing system also includes inkjet print heads 230, 231, 232, 233. The inkjet print heads are positioned with respect to the pretreatment head to form a printed image on the media substrate after the plasma treatment. The inkjet print heads can be used to print different colors, such as cyan, magenta, yellow, black, blue, green, red, purple, orange, gray, etc. In certain examples, the colors may be cyan, magenta, and yellow (three colors); or cyan, magenta, yellow, and black (four colors). The inkjet print heads may also be in fluid communication with ink reservoirs 240, 241, 242, 243, and may carry the inks. The media substrate, as shown, can be conveyed past the pretreatment head and the inkjet print heads by conveyors 250.

As shown in FIG. 2A, the pretreatment head 210 and the inkjet print heads 230, 231, 232, and 233 can be positioned a small distance above the surface of the polyolefin media substrate 220. The inkjet print heads can be positioned at a distance typically used in inkjet printing. In various examples, the pretreatment head can be positioned over a range of distances from the media substrate. In one example, the pretreatment head can be positioned such that the surface barrier discharge plasma generator is up to 10 mm from the surface of the media substrate. For example, the surface barrier discharge plasma generator can be from 0.1 mm to 10 mm from the surface of the media substrate. In another example, the surface barrier discharge plasma generator can be in direct contact with the surface of the media substrate. Depending on the distance of the surface barrier discharge plasma generator from the media substrate, the media substrate can be within the plasma arcs or beneath the plasma arcs. In some examples, the media substrate can be effectively treated either within the plasma arcs or beneath the plasma arcs. In further examples, the pretreatment head can be fixed at a distance from the media substrate, or moveable with respect to the media substrate so that the distance can be adjusted.

FIG. 2B shows a schematic top view of the printing system of FIG. 2A. As shown in FIG. 2B, the pretreatment head 210 and inkjet print heads 230, 231, 232, 233 can have nearly the same width as the polyolefin media substrate 220. In certain examples, the surface barrier discharge plasma generator 215 can be 75% or more as wide as the media substrate, or 90% or more as wide as the media substrate. In further examples, the surface barrier discharge plasma generator can be as wide as the media substrate or wider.

In some examples, the pretreatment head and inkjet print heads can be held stationary while the polyolefin media substrate is conveyed past. Thus, in one example, the pretreatment head can plasma treat the entire width of the media substrate or a portion of the media substrate as wide as the surface barrier discharge plasma generator. After the media substrate is plasma treated, the inkjet print heads can print ink onto the media substrate as the media substrate is conveyed past. In other examples, it may be that the pretreatment head and/or the inkjet print heads may also be movable on a carriage and traverse the media substrate. In other words, in the example shown, these features are static, but they may alternatively be movable.

The plasma treatment can effectively modify the surface of the media substrate very quickly so that distance between the pretreatment head and the inkjet print heads is not particularly limiting, e.g., many different distances can be used. Additionally, the plasma treatment can retain its effect on the surface of the media substrate for an extended time, such as more than one month or more than one year. Thus, no particular proximity of distance or time between use of the pretreatment head and the inks impact the result. However, in some examples, the pretreatment head can be positioned directly adjacent to the inkjet print heads. In other examples, the pretreatment head can be positioned any convenient distance from the inkjet print heads, such as from 1 mm to 10 meters away from the inkjet print heads.

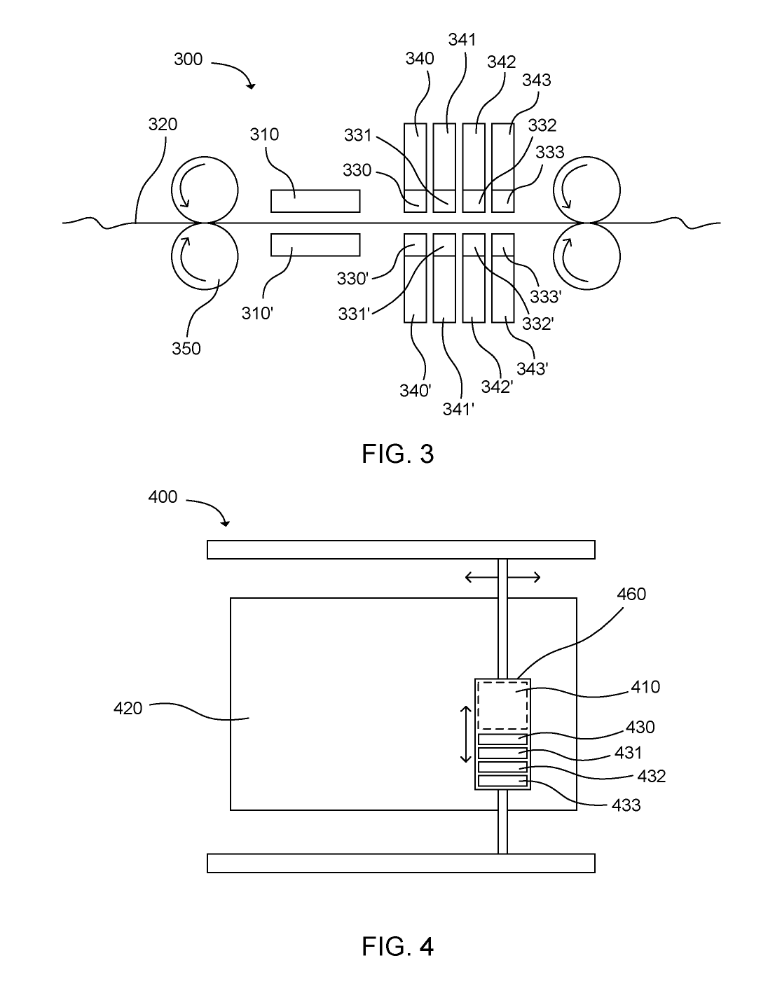

It should be noted that the example shown in FIGS. 2A and 2B is only a single example of the presently disclosed technology. In other examples, printing systems according to the present disclosure can have a variety of different configurations. FIG. 3 shows another example of a printing system 300 that includes a pretreatment head 310 and inkjet print heads 330, 331, 332, 333 in fluid communication with ink reservoirs 340, 341, 342, 343. These components are positioned to pretreat and print on a first surface of the polyolefin media substrate 320. Another pretreatment head 310′ and inkjet print heads 330′, 331′, 332′, 333′ in fluid communication with ink reservoirs 340′, 341′, 342′, 343′ are positioned on an opposite side of the media substrate to pretreat and print the opposite surface of the media substrate. The media substrate is conveyed between the two sets of pretreatment heads and inkjet print heads by conveyors 350. Thus, the system can pretreat and print on both surfaces of the media substrate simultaneously.

In other examples, the pretreatment head and/or the inkjet print head can be movable with respect to the polyolefin media substrate. For example, in a web fed printing system the pretreatment head and/or inkjet print head can move in a direction perpendicular to the movement direction of the media web. In another example, the printing system can be sheet fed. A polyolefin media substrate sheet can be fed by conveyors past a pretreatment head and inkjet print head, while the pretreatment head and/or inkjet print head can move in a direction perpendicular to the movement direction of the media sheet. In a further example, the printing system can have a static printing bed on which a media substrate sheet is placed. The pretreatment head and/or the inkjet print head can move in two dimensions (i.e., the x-axis and y-axis directions) over the media substrate sheet to pretreat and print on the media substrate sheet.

FIG. 4 shows an example of a printing system 400 including a stationary polyolefin media substrate sheet 420. In this system, a pretreatment head 410 and inkjet print heads 430, 431, 432, 433 are located together on a carriage 460. The carriage is moveable in the x-axis and y-axis directions so that the pretreatment head can pretreat portions of the media substrate sheet, after which the inkjet print heads can print on the pretreated portions.

Although the above examples have been described as employing a surface barrier discharge plasma generator, other types of plasma generators may also be used to pretreat the polyolefin media substrate. In one example, the plasma generator can be a parallel plate plasma with electrodes located on both sides of the polyolefin media substrate. A dielectric layer can also be positioned between the electrodes. Plasma can form in the volume between the electrodes when a high voltage, high frequency current is applied to the electrodes.

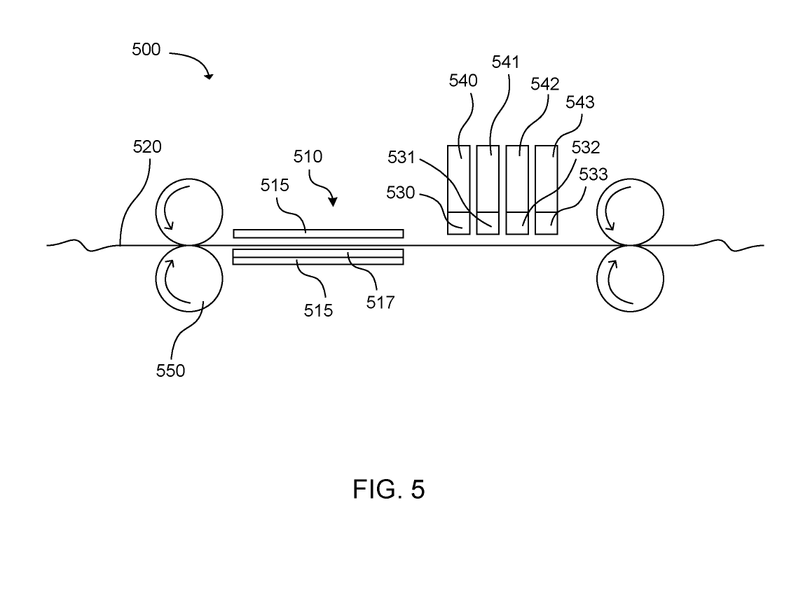

FIG. 5 shows an example of a printing system 500 including a parallel plate plasma generator 510. The parallel plate plasma generator includes two electrodes 515 located above and below a polyolefin media substrate 520. A dielectric layer 517 is also located between the electrodes. The parallel plate plasma generator is thus positioned to plasma treat the media substrate. Inkjet print heads 530, 531, 532, 533 are positioned to print on the media substrate after the plasma treatment. The inkjet print heads are in fluid communication with reservoirs 540, 541, 542, 543 which include inkjet inks. The media substrate is conveyed past the parallel plate plasma generator and the inkjet print heads by conveyors 550.

As mentioned above, the printing systems described herein can include an inkjet print head. In some examples, a printing system can include a single inkjet print head. The inkjet print head can be in fluid communication with a reservoir of black ink or a colored ink. In other examples, the printing system can include multiple inkjet print heads. For example, the printing system can include an inkjet print head for several different colors, such as cyan, magenta, yellow, and black. In further examples, other colors of ink can be included.

As used herein, “inkjetting” or “jetting” refers to ejecting compositions from jetting architecture, such as inkjet architecture. Inkjet architecture can include thermal, piezo, or continuous inkjet architecture. A thermal inkjet print head can include a resistor that is heated by electric current. Inkjet ink can enter a firing chamber and the resistor can heat the ink sufficiently to form a bubble in the ink. The expansion of the bubble can cause a drop of ink to be ejected from a nozzle connected to the firing chamber. Piezo inkjet print heads are similar, except that instead of a thermal resistor, a piezoelectric element is used to mechanically force a drop of ink out of a nozzle. In a continuous inkjet printing system, a continuous stream of ink droplets is formed and some of the droplets can be selectively deflected by an electrostatic field onto the media substrate. The remaining droplets may be recirculated through the system. Inkjet print heads can be configured to print varying drop sizes such as less than 10 picoliters, less than 20 picoliters, less than 30 picoliters, less than 40 picoliters, less than 50 picoliters, etc.

In some cases, the ink used in the printing systems described herein can be a water-based inkjet ink or a solvent-based inkjet ink. Inkjet inks generally include a colorant dispersed or dissolved in an ink vehicle. As used herein, “liquid vehicle” or “ink vehicle” refers to the liquid fluid in which a colorant is placed to form an ink. A wide variety of ink vehicles may be used with the methods of the present disclosure. Such ink vehicles may include a mixture of a variety of different agents, including, surfactants, solvents, co-solvents, anti-kogation agents, buffers, biocides, sequestering agents, viscosity modifiers, surface-active agents, water, etc.

Generally the colorant discussed herein can include a pigment and/or dye. As used herein, “dye” refers to compounds or molecules that impart color to an ink vehicle. As such, dye includes molecules and compounds that absorb electromagnetic radiation or certain wavelengths thereof. For example, dyes include those that fluoresce and those that absorb certain wavelengths of visible light. In most instances, dyes are water soluble or solvent soluble. In some examples, the colorant can be a dye. In a specific example, the colorant can be a solvent-soluble dye. Solvent soluble dyes can be soluble in organic solvents such as ethanol in amounts of 5 wt % or more.

Furthermore, as used herein, “pigment” generally includes pigment colorants, magnetic particles, aluminas, silicas, and/or other ceramics, organo-metallics or other opaque particles. In one example, the colorant can be a pigment. In a further example, the colorant can be an anionic pigment that can interact with cationic species and/or oxygen containing groups at the surface of the media substrate that has been treated with the surface barrier discharge plasma generator as described herein. For instance, the pigment can include an anionic dispersing group or anionic dispersant molecule that is sensitive to multivalent cations such as Ca²⁺. In some specific examples, the anionic dispersing group or dispersant molecule can include carboxylate or phosphonate functionalities.

In certain examples, the colorant can be a pigment having a dispersing group covalently bonded to surfaces of the pigment. The dispersing groups can be, for example, small groups, oligomeric groups, polymeric groups, or combinations thereof. In other examples, the pigment can be dispersed with a separate dispersant. Suitable pigments include, but are not limited to, the following pigments available from BASF: Paliogen® Orange, Heliogen® Blue L 6901F, Heliogen® Blue NBD 7010, Heliogen® Blue K 7090, Heliogen® Blue L 7101F, Paliogen® Blue L 6470, Heliogen® Green K 8683, and Heliogen® Green L 9140. The following black pigments are available from Cabot: Monarch® 1400, Monarch® 1300, Monarch® 1100, Monarch® 1000, Monarch® 900, Monarch® 880, Monarch® 800, and Monarch® 700. The following pigments are available from CIBA: Chromophtal® Yellow 3G, Chromophtal® Yellow GR, Chromophtal® Yellow 8G, Igrazin® Yellow 5GT, Igralite Rubine 4BL, Monastral® Magenta, Monastral® Scarlet, Monastral® Violet R, Monastral® Red B, and Monastral® Violet Maroon B. The following pigments are available from Degussa: Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: Tipure® R-101. The following pigments are available from Heubach: Dalamer® Yellow YT-858-D and Heucophthal Blue G XBT-583D. The following pigments are available from Clariant: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B. The following pigments are available from Mobay: Quindo® Magenta, Indofast® Brilliant Scarlet, Quindo® Red R6700, Quindo® Red R6713, and Indofast® Violet. The following pigments are available from Sun Chemical: L74-1357 Yellow, L75-1331 Yellow, and L75-2577 Yellow. The following pigments are available from Columbian: Raven® 7000, Raven® 5750, Raven® 5250, Raven® 5000, and Raven® 3500. The following pigment is available from Sun Chemical: LHD9303 Black. Any other pigment and/or dye can be used that is useful in modifying the color of the ink. Additionally, the colorant can include a white pigment such as titanium dioxide, or other inorganic pigments such as zinc oxide and iron oxide.

In further examples, the ink can include a binder. In some examples, the binder can be a latex polymer. In further examples, the binder can include polymers, copolymers, or combinations thereof. The polymers and copolymers can be formed of styrene, acrylic acid, methacrylic acid, methyl methacrylate, butyl acrylate, divinylbenzene, or combinations thereof. In another example, the binder can be a polyurethane binder. In some cases the binder can be curable. That is, the binder can be further polymerized or cross-linked after the ink is printed onto the media substrate.

In some examples, liquid vehicle formulations that can be used in the ink can include water and one or more co-solvents. The co-solvents can be present in total at from 1 wt % to 50 wt %, depending on the jetting architecture. Further, one or more non-ionic, cationic, and/or anionic surfactants can be present, ranging from 0.01 wt % to 20 wt % (if present). In one example, the surfactant can be present in an amount from 0.1 wt % to 20 wt %. The liquid vehicle can also include dispersants in an amount from 0.1 wt % to 20 wt %. The balance of the formulation can be purified water, or other vehicle components such as biocides, viscosity modifiers, materials for pH adjustment, sequestering agents, preservatives, and the like. In one example, the liquid vehicle can be more than 50 wt % water.

In further examples, the liquid vehicle can be a non-aqueous, solvent-based vehicle. In one example, the liquid vehicle can include ethanol and additional co-solvents. In one example, ethanol can be present in the ink at from 10 wt % to 90 wt %. Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Surfactants that can be included in the ink can include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. Suitable surfactants can include, but are not limited to, liponic esters such as Tergitol™ 15-S-12, Tergitol™ 15-S-7 available from Dow Chemical Company, LEG-1 and LEG-7; Triton™ X-100; Triton™ X-405 available from Dow Chemical Company; LEG-1, and sodium dodecylsulfate.

Various other additives may be employed to enhance the properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, NUOSEPT® (Nudex, Inc.), UCARCIDE™ (Union carbide Corp.), VANCIDE® (R.T. Vanderbilt Co.), PROXEL® (ICI America), ACTICIDE® (Thor Specialties Inc.) and combinations thereof. Sequestering agents such as EDTA (ethylenediaminetetraacetic acid) may be included to eliminate the deleterious effects of heavy metal impurities. From 0.001% to 2.0% by weight, for example, can be used. Viscosity modifiers may also be present, as well as other additives known to those skilled in the art to modify properties of the ink as desired. Such additives can be present at from 0.01% to 20% by weight.

In some examples, the inkjet ink can include ingredients in the amounts listed in Table 1:

TABLE 1

| Component | Weight Percent |
|---|---|
| Binder | 0.5-10% |
| Biocide | 0-5% |
| Surfactant | 0-10% |
| Anti-kogation agent | 0-5% |
| Colorant | 0.5-10% |
| Organic Co-solvent | 0.1-50% |
| Ethanol* | Balance |

*Note that by “balance,” what is meant is that ethanol is used to achieve 100 wt %. Other ingredients other than the ones shown in Table 1 may be present, and ethanol is used to arrive at 100 wt %, regardless of what other ingredients are present.

The polyolefin media substrate used in the printing system can be any of a wide variety of polyolefin materials. Several examples include polyethylene, polypropylene, oriented polypropylene (OPP), biaxially oriented polypropylene (BOPP), low density polyethylene (LDPE), linear low density polyethylene (LLDPE), very low density polyethylene (VLDPE), high density polyethylene (HDPE), high density high molecular weight polyethylene (HD-HMW-PE), ultrahigh molecular weight polyethylene (UHMWPE), and combinations thereof. In some examples, the polyolefin media substrate can be in the form of a sheet or film. In certain examples, the polyolefin media substrate can be a flexible film web formed as a roll to be used with a web fed printing system. In a specific example, the polyolefin media substrate can be a packaging material such as a film for forming potato chip bags or other similar packaging. Printing words and images on packaging material can be useful on packaging for a wide variety of products. In particular, a digital printing system such as the inkjet systems described herein can be useful for printing product lot numbers, bar codes, expiration dates, and other text or images that are periodically changed.

In further examples, the polyolefin media substrate can be a three-dimensional object such as a molded or cast polyolefin article. Several examples include blow-molded containers such as bottles, injection molded articles, and cast articles. In further examples, the polyolefin media substrate can be a textile formed of a polyolefin material, such as a woven textile or a nonwoven textile.

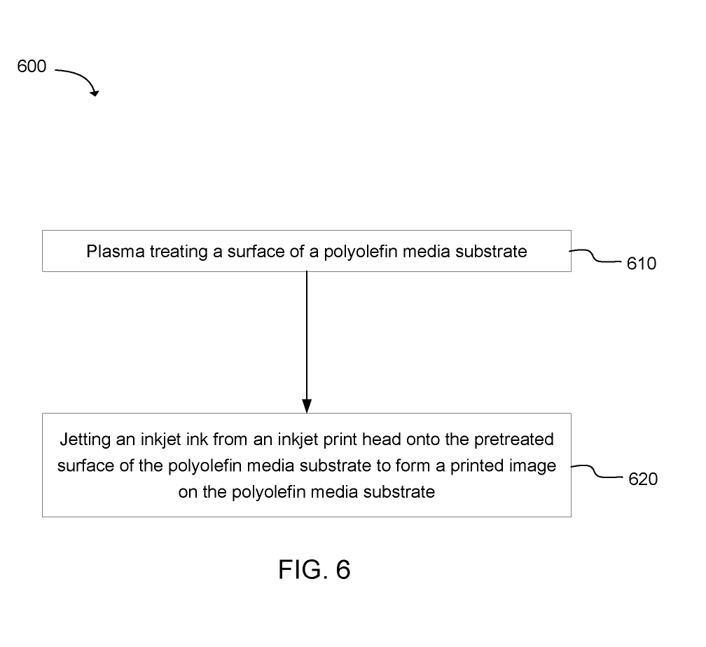

The present disclosure also includes methods of forming a printed image on a media substrate. FIG. 6 shows one example of a method 600 of forming a printed image on a media substrate. The method includes plasma treating a surface of a polyolefin media substrate 610; and jetting an inkjet ink from an inkjet print head onto the pretreated surface of the polyolefin media substrate to form a printed image on the polyolefin media substrate 620.

In some examples, pretreating the surface of the polyolefin media substrate with plasma can increase the wettability of the surface. Thus, the printed inkjet ink can have reduced coalescence compared to ink printed onto an untreated polyolefin media substrate. Reducing coalescence can improve print quality by allowing the colorant in the ink to be spread over the entire printed area instead of coalescing into smaller droplets due to non-wetting of the polyolefin media substrate.

In various examples, the plasma treatment can be performed at a distance from the media substrate up to 10 mm away from the media substrate. As described above, in some cases the plasma generator can be a surface barrier discharge plasma generator placed in direct contact with the media substrate during the plasma treatment. In other cases the surface barrier discharge plasma generator can be separated by a distance from the media substrate. For example, the distance can be small enough that the media substrate passes through the plasma arcs generated by the plasma generator. However, in other examples the distance can be greater than the depth of the plasma arcs so that the plasma arcs are located above the surface of the media substrate. In another example, the plasma generator can be a parallel plate plasma generator. The polyolefin media substrate can be in direct contact with the dielectric layer of the parallel plate plasma generator, or the polyolefin media substrate can pass between the parallel plates without touching either plate or the dielectric layer.

In further examples, the plasma treatment can be performed for a time period of 0.1 second to 20 seconds. In more specific examples, the time period can be 0.2 second to 10 seconds or 0.5 second to 5 seconds. As used herein, the time period of the plasma treatment refers to the amount of time that a treated portion of the media substrate is exposed to the plasma. As explained above, the media substrate may be in direct contact with the plasma arc or merely have the plasma arc passed over the media substrate. In the case of a web-fed printing system, the media substrate can constantly move past the plasma generator. Thus, the time period of the plasma treatment can be the time required for a point on the media substrate to travel across the length of the plasma generator. In examples where the printing system includes the plasma generator on a carriage, the plasma generator can either be held stationary over a portion of the media substrate for the pretreatment time period, or the carriage can move at an appropriate speed so that each portion of the media substrate is pretreated for the appropriate time period.

Generally, longer pretreatment time periods can provide better printing results, as signified by higher optical density and color saturation. However, in some examples a maximum effect can be reached after a certain time period. This time period can be from 0.1 second to 20 seconds or any of the other time periods described above. In further examples, the distance of the plasma generator from the media substrate can affect the time period required to reach the maximum pretreatment effect. At greater distances, a longer time period may be required.

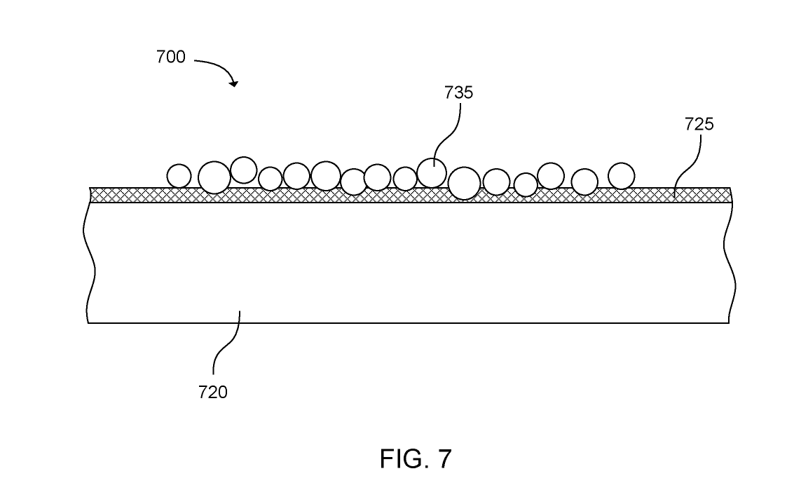

The present disclosure also includes printed articles made using the systems and methods described herein. FIG. 7 shows one example of a printed article 700. The printed article includes a polyolefin media substrate 720 having a surface 725 modified by a surface barrier discharge plasma generator to form oxygen containing groups on the surface. A printed image is formed by jetting an inkjet ink on the modified surface of the polyolefin media substrate. The printed image includes a colorant 735 in contact with the modified surface of the media substrate.

In some examples, the printed image can have improved print quality compared to a printed image on the same polyolefin media substrate without the plasma treatment. For example, the optical density and color saturation can be improved compared to a printed image on an untreated polyolefin media substrate. In certain examples, the printed image can be formed with a black inkjet ink, and the black optical density (KOD) of the image can be 1 or more. As used herein, “KOD” is defined as:

KOD=log₁₀(1/R) (1)

where R is the reflectance of the printed substrate. Optical density is a function of the percentage of light reflected. For example, if 100% of light is reflected, then the optical density is zero. If 10% of light is reflected, then the optical density is 1. In addition to improving optical density, the plasma treatment can significantly reduce coalescence of the ink printed onto the polyolefin media substrate.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

In this disclosure, “comprises,” “comprising,” “having,” “includes,” “including,” and the like, and are generally interpreted to be open ended terms. The term “consisting of” is a closed term, and includes only the methods, compositions, components, steps, or the like specifically listed. “Consisting essentially of” or “consists essentially” or the like, when applied to methods, compositions, components, steps, or the like encompassed by the present disclosure, refers to elements like those disclosed herein, but which may contain additional composition components, method steps, etc., that do not materially affect the basic and novel characteristic(s) of the compositions, methods, etc., compared to those of the corresponding compositions, methods, etc., disclosed herein. When using an open ended term, like “comprising” or “including,” it is understood that direct support should be afforded also to “consisting essentially of” language as well as “consisting of” language as if stated explicitly, and vice versa.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

Percentages, ratios, and parts refer to weight percentages, weight ratios, and parts by weight unless otherwise specified or otherwise clear from the surrounding context.

As a further note, in the present disclosure, it is noted that when discussing the printing systems, methods of forming a printed image, and printed articles, each of these discussions can be considered applicable to each of these examples, whether or not they are explicitly discussed in the context of that example. Thus, for example, in discussing details about the printing system per se, such discussion also refers to the methods and the printed articles described herein, and vice versa.

The following examples illustrate aspects of the present technology. However, it is to be understood that these examples are only exemplary or illustrative of the application of the principles of the present systems and methods. Numerous modifications and alternative systems, methods, compositions, media, and so on may be used without departing from the spirit and scope of the present disclosure. The appended claims are intended to cover such modifications and arrangements. Thus, while the technology has been described with particularity, the following examples provide further detail in connection with the present technology.

### EXAMPLES

### Example 1

A surface barrier discharge plasma generator was used to treat a biaxially oriented polypropylene (BOPP) film. The BOPP film had not been corona treated by the manufacturer. The plasma generator was held by hand and passed over the surface of the BOPP film at a rate of approximately 0.7 inches per second (ips). The plasma generator was model RPS40 from ROPLASS S.R.O. This plasma generator has the following specifications:

TABLE 2
ROPLASS RPS40 Specifications

| | |
|---|---|
| Power (W) | 40 |
| Plasma Area (cm²) | 7.5 |
| Plasma Depth (cm) | 0.03 |
| Frequency (kHz) | 25 |
| Voltage (kV, peak to peak) | 15 |

After pretreating the BOPP film with the plasma generator, a test pattern was printed with an inkjet printer on the BOPP film with a black solvent-based ink (HP 2580 black solvent ink). The test pattern was printed at 300×300 dots per inch (dpi) at a speed of 25 ips. For comparison, the same test pattern was printed on BOPP film that had not been pretreated with the plasma generator.

The test pattern printed after the plasma pretreatment had significantly better print quality than the test pattern printed without the plasma pretreatment. The test pattern printed with the plasma pretreatment had an even, black appearance. The test pattern printed without the plasma pretreatment had a high degree of coalescence, resulting in light or white areas interspersed with very dark areas of coalesced ink.

### Example 2

The ROPLASS RPS40 plasma generator was mounted on a carriage with the print head of an ink jet printer. A sheet of BOPP film was loaded in the printer. The printer was configured to move the carriage so that the plasma generator would pass over the BOPP film before the inkjet print head printed on the film.

A test pattern was printed on the BOPP film with the plasma generator turned on to pretreat the BOPP film before printing. For comparison, the same test pattern was printed with the plasma generator turned off. The ink used for printing was HP 2580 black solvent ink. The test pattern was printed at 300×300 dots per inch (dpi) at a speed of 25 ips.

Again, the test pattern printed after the plasma pretreatment had significantly better print quality than the test pattern printed without the plasma pretreatment. The test pattern printed with the plasma pretreatment had an even, black appearance. The test pattern printed without the plasma pretreatment had a high degree of coalescence, resulting in light or white areas interspersed with very dark areas of coalesced ink. KOD of the test patterns were measured using a GretagMacbeth Spectrolino™ CH9105 color measurement device using D65 illuminant at 2 degrees observer angle and reflectance mode. The test pattern printed with the plasma pretreatment had a KOD of 1.04, while the KOD of the test pattern printed without the plasma pretreatment had a KOD of only 0.18.

While the disclosure has been described with reference to certain examples, various modifications, changes, omissions, and substitutions can be made without departing from the spirit of the disclosure. It is intended, therefore, that the disclosure be limited only by the scope of the following claims.

What is claimed is:

1. A printing system, comprising:
a polyolefin media substrate;
a pretreatment head comprising a plasma generator to apply a plasma treatment to the polyolefin media substrate; and
an inkjet print head positioned with respect to the pretreatment head to form a printed image on the polyolefin media substrate after the plasma treatment.

2. The printing system of claim 1, wherein the plasma generator is a surface barrier discharge plasma generator.

3. The printing system of claim 1, wherein the surface barrier discharge plasma generator is positioned or movable to operate at from 0.1 mm to 10 mm from the polyolefin media substrate.

4. The printing system of claim 1, wherein the polyolefin media substrate is a media web that is web fed, and wherein the surface barrier discharge plasma generator is 75% or more as wide as the media web.

5. The printing system of claim 1, wherein the pretreatment head and inkjet print head are attached to a carriage for passing the pretreatment head over a portion of the polyolefin media substrate to apply the plasma treatment followed by passing the inkjet print head over the polyolefin media substrate to form the printed image on the portion.

6. The printing system of claim 1, wherein the polyolefin media substrate comprises polyethylene, polypropylene, oriented polypropylene, biaxially oriented polypropylene, low density polyethylene, linear low density polyethylene, very low density polyethylene, high density polyethylene, high density high molecular weight polyethylene, ultrahigh molecular weight polyethylene, or combinations thereof.

7. The printing system of claim 1, wherein the polyolefin media substrate has a form factor comprising a film, woven textile, a nonwoven textile, a blow molded article, an injection molded article, or a cast article.

8. The printing system of claim 1, further comprising an ink reservoir in fluid communication with the inkjet print head, the ink reservoir comprising an inkjet ink, wherein the inkjet ink comprises a solvent-soluble dye.

9. The printing system of claim 8, wherein the inkjet ink is nonaqueous and comprises from 50 wt % to 95 wt % ethanol.

10. A method of forming a printed image on a polyolefin media substrate, comprising:
plasma treating a surface of a polyolefin media substrate; and
jetting an inkjet ink from an inkjet print head onto the pretreated surface of the polyolefin media substrate to form a printed image on the polyolefin media substrate.

11. The method of claim 10, wherein the inkjet ink comprises a solvent-soluble dye.

12. The method of claim 10, wherein plasma treating is performed utilizing a surface barrier discharge plasma generator.

13. The method of claim 10, wherein plasma treating is performed for a time period of 0.1 second to 20 seconds prior to jetting.

14. A printed article, comprising:
a polyolefin media substrate having a surface thereof modified by surface barrier discharge plasma generator to convert polyolefin molecules at the surface into oxygen containing groups; and
a printed image formed by jetting an inkjet ink on the modified surface of the polyolefin media substrate, wherein the printed image comprises a colorant in contact with the modified surface of the polyolefin media substrate.

15. The printed article of claim 14, wherein the printed image includes black ink having a KOD of 1 or more.
